(19) United States
(12) Patent Application Publication
(10) Pub. No.: US 2005/0125556 A1
(43) Pub. Date: Jun. 9, 2005

(54) Data movement management system and method for a storage area network file system employing the data management application programming interface

(75) Inventors: Robert J. Curran, West Hurley, NY (US); Radha R. Kandadai, Lake Katrine, NY (US); Irit Loy, Binyamina (IL); John M. Marberg, Haifa (IL)

Correspondence Address: Lawrence D. Cutter, Attorney;IBM Corporation, Intellectual Property Law Dept., 2455 South Rd., M/S P386, Poughkeepsie, NY, 12601, US

(73) Assignee: INTERNATIONAL BUSINESS MACHINES CORPORATION, ARMONK, NY (US)

(21) Appl. No.: 10/730,508

(22) Filed: Dec. 8, 2003

(51) Int. Cl. G06F 15/173

(52) U.S. Cl. 709/238

(57) ABSTRACT

A system and method of managing data movement are provided in which a processing environment is established in a cluster of nodes. The nodes have common access to data residing in one or more data storage units. A data management application (DM) is initiated in the environment. One of the nodes of the cluster is assigned as a coordinating node for managing data movement. Thereafter, a worker thread is posted to one or more of the nodes in the cluster to perform one or more data movement tasks in response to the event. Preferably, a process session is established in the cluster. A session identifier and a data management access right are provided to one or more nodes to permit only the node or nodes having them to execute the worker thread posted to it.

### BACKGROUND OF THE INVENTION

The present invention relates to computing systems, and more particularly to a system and method for managing the movement of data to and from storage in a computing environment.

With the advent of technology, computing environments are becoming more complex such that they often include a cluster of smaller computer systems networked to one another. Such environments necessarily share data and resources, which often lead to problems associated with availability of common resources, data management and compatibility of platforms.

Processing speed is a key ingredient in resolving issues related to resource availability. Consequently, in recent years storage area networks (hereinafter “SANs”) have become a major addition to such environments. SANs provide direct, high speed physical connections, such as Fibre Channel connections, between different components and substantially improve processing speed of all or parts of such environments.

Another important factor that affects processing speed is the ease and speed that data is moved throughout the system. Data can be stored in a storage unit residing permanently in the system, or may reside in more temporary storage units such as tape drive and other secondary storage. Therefore quick data accessibility is key for any node in fast command execution and task performance, no matter whether the data resides permanently or temporarily in the cluster.

Another consideration in resolving data management concerns involves compatibility. In order to provide seamless computing, data must move freely throughout the environment. This means that data has to be processed, stored and retrieved regardless of the devices, operating systems and programs operating in the environment. Consequently data needs to be organized in a manner that makes such processing, retrieval and storage manageable.

To address data movement concerns, the industry has selected standards to provide platform-independent interfaces and programs. The Data Management Application Programming Interface standard (hereinafter “DMAPI”) is one such example. DMAPI is developed by the Data Management Interface Group (DMIG) and provides a consistent, platform independent interface for data management (DM) applications. DMAPI deals directly with data movement issues in a large cluster and aids data management by allowing DM applications to be developed in much the same way as any ordinary user application. Furthermore, a set of standard interface functions are offered by DMAPI that provides the developers the tools they need for monitoring and controlling data (i.e. file) use, without requiring them to modify the operating system kernel.

DMAPI is described in detail in a specification document published by the Open Group (www.opengroup.org), entitled “Systems Management: Data Storage Management (XDSM) API” (Open Group Technical Standard 1997), which is incorporated herein by reference. This document is available at www.opengroup.org.

DMAPI has traditionally been used in computing environments that do not use SANs. Recent incorporation of SANs in computing environments, however, have made it necessary that SAN environments also rely on DMAPI at least for hierarchal storage management tools.

Incorporation of DMAPI into SAN environments is challenging and often involves undue restrictions. Prior approaches to incorporating DMAPI in SAN environments have limited data accessibility by requiring use of a mirror server, thus affecting performance and adding cost and complexity to data processing. In other approaches, the prior art requires changes to the running operating system or even to the DMAPI standard itself, both of which are undesirable. Neither such approach is desirable.

Commonly owned applications were previously filed that describe approaches for utilizing the DMAPI standard (including Xopen) in SAN file systems. These commonly owned applications are U.S. application Ser. Nos. 09/887,520; 09/887,533; 09/887,549; 09/887,550; and 09/887,576, all filed Jun. 25, 2001 and all incorporated by reference herein. In these filings, the use of the DMAPI standard is provided without modification. However, all data migration and recall is conducted through a single node called a session node. To improve performance of some complex systems, it would be better if multiple nodes can be engaged in the retrieval and processing of data. In addition, although a mechanism using a replacement node may be introduced in the event of a failure, the use of multiple nodes, nonetheless, allows for better data recovery in the event of such failures.

Consequently, it would be desirable to utilize multiple nodes for data movement under coordination of a DMAPI application on a single session node to enhance performance without altering the operating system, the components of the computing environment or the DMAPI standard.

### SUMMARY OF THE INVENTION

A system and method of managing data movement are provided in which a processing environment is established in a cluster of nodes. The nodes have common access to data residing in one or more data storage units. A data management application (DM) is initiated in the environment. One of the nodes of the cluster is assigned as a coordinating node for managing data movement. Thereafter, a worker thread is posted to one or more of the nodes in the cluster to perform one or more data movement tasks in response to the event.

According to a preferred aspect of the invention, a process session is established in the cluster. A session identifier is provided to a node to permit that node to execute the worker thread posted to it. In an embodiment, a data management access right is also provided to the node to which the worker thread is posted or dispatched. Only the node(s) having the session identifier and the data management access right are permitted to execute the worker thread.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 is a block and schematic diagram illustrating a general organization of a computing environment in which the embodiments of the invention operate;

FIG. 2 is a block and schematic diagram illustrating a system embodiment of the invention;

FIG. 3 illustrates a storage area network (SAN) and its component layers;

FIG. 4 is a flowchart illustrating a data movement method according to an embodiment of the invention;

FIG. 5 is a flowchart illustrating a detailed method according to an embodiment of the invention; and

FIG. 6 is a flowchart illustrating a sequence of operations performed according to a preferred embodiment in case of a failure of a coordinating node.

### DETAILED DESCRIPTION OF THE INVENTION

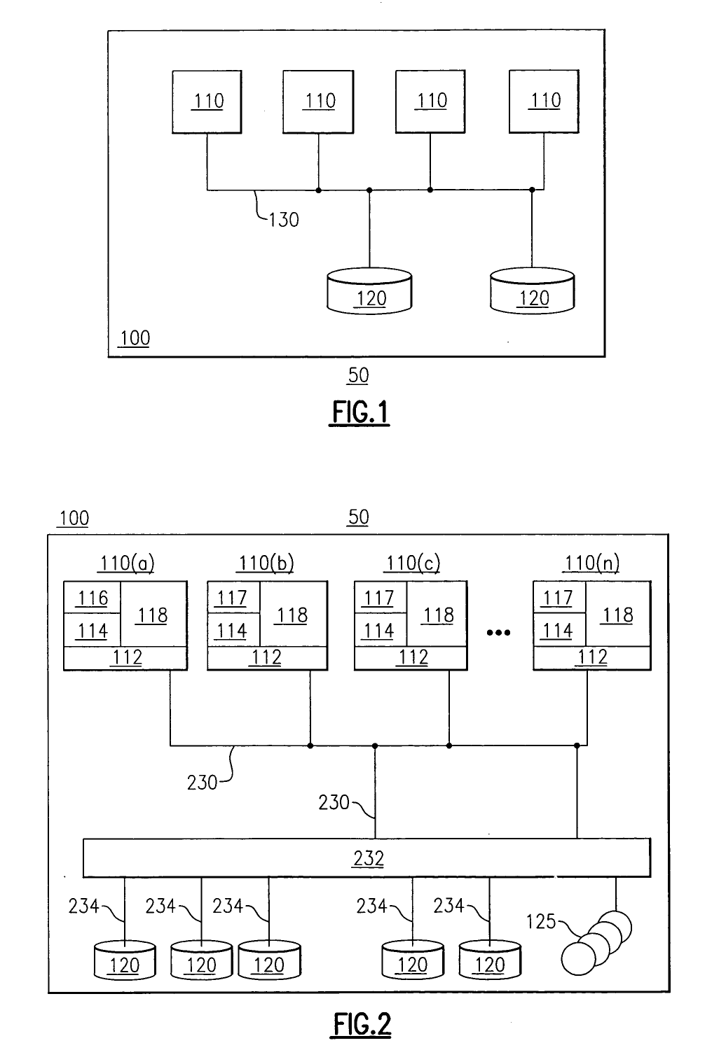

The subject matter of the present invention can be applied to a computing environment, as shown at 50 comprising of one or more clusters 100 as shown in FIG. 1. FIG. 1 is a block diagram of such a computing environment 50 which is simplified for reference purposes to illustrate only one of its clusters 100, with the understanding that computing environments with a plurality of clusters can also take advantage of the subject matter of the present invention.

FIG. 1 also provides a schematic illustration of the cluster 100. As shown, cluster 100 includes a plurality of computing nodes 110. The nodes 110 each have a unique identity. Each node 110 includes a single computing device or a conventional computer system including one or more local or main memory components, displays, printers, input output (I/O) devices, or computer devices that are networked together.

The nodes 110 are in processing communication with one another as well as with one or more storage units 120. The storage units may also be networked so that they are in processing communication with one another directly or through other nodes indirectly. As illustrated in FIG. 1, storage units include storage disks but other storage devices, such as tape drives, semiconductor memories, and the like can be used instead or in addition to the storage disks already mentioned.

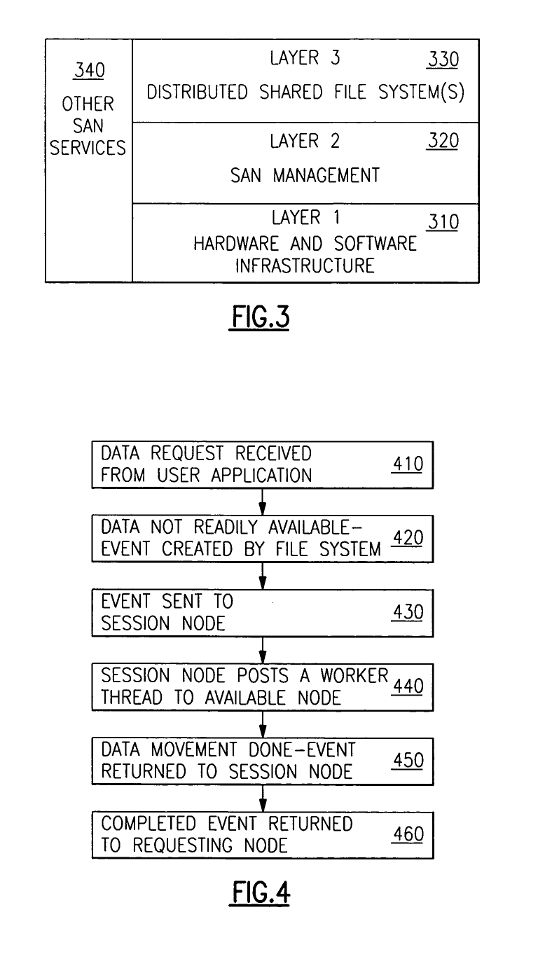

Processing communication between nodes, between storage units and nodes is established through an interconnection means generally shown at 130. The interconnection means can be very simple, having only a few links, or be complex, including routers, high capacity lines, switches and other similar components. In a preferred embodiment, one or more storage area networks (hereinafter SANs) are provided as part of such a communication network. SANs are preferred due to their ability to provide direct, high-speed physical connections, such as Fibre Channel connections, between the nodes 110, storage units including storage disks 120 and/or between the nodes 110 and the storage disks 120. Particular issues and needs of and embodiment including a SAN will be later discussed in detail in conjunction with FIGS. 2 and 3.

The computing environment of FIG. 1 is set up in parallel so that all the nodes 110 in the cluster 100 can share resources, including storage disks, and can have data access to all the information residing in the cluster 100 when necessary. This allows all nodes and/or resources to be able to participate in processing tasks when appropriate, either independently or collaboratively.

Data residing in the cluster 100 is organized in files arranged according to a file system. Since the computing environment is set up in a parallel arrangement to allow data processing to be conducted in parallel, it follows that a parallel file system that can handle one or more operating platforms has to be employed in such an environment. A parallel file system can be described as a hierarchical collection of files and file directories that are stored on disk or other medium and have an identified root and a predefined interface.

The parallel file system includes one or more physical file systems shown as 112 in FIG. 1, running on a cluster of nodes which enables all nodes in the cluster to access the same file data concurrently. In a preferred embodiment, all nodes share in the management of the file systems. Any of the nodes can perform any role required to manage the file systems, with specific roles assigned to particular nodes as needed.

The physical file system(s) is provided in form of a software component to manage collections of data in such hierarchical of files (and stored on the storage disks 120). In a preferred embodiment, a physical file system prescribed by the X/Open and Posix standards is used.

The physical file system is one of the layers in the hierarchy of interfaces that are used to support the file systems and to enable software applications to access the file data. Multiple different physical file systems may coexist on a computer and each one may be used to implement a different type of file system. Most physical file systems run in the kernel with possible extensions running as daemons in the user file space.

FIG. 2 is a block diagram illustrating an embodiment of the invention in which the environment 50 includes a cluster 100 of nodes 110 similar to that shown in FIG. 1. In FIG. 2, however, each node 110(a) though 110(n) is identified individually so as to differentiate them from one another. FIG. 2 also incorporates a storage area network (SAN) interface by way of example, although the teachings of the present invention can be as easily applied to a cluster that does not include a SAN interface. As shown, the cluster 100 includes a SAN network 230 in which mass or secondary storage such as disk drives 120, and other storage units such as tape drives 125 may be present and networked together with the nodes 110(a) through 110(n). These storage units are connected to the nodes 110(a) though 110(n) via a Fibre Channel switch 232 and Fibre Channel connections 234. The nodes may also be connected via a local area network (LAN) (not shown). An example of such a LAN 225 is an Ethernet using a common protocol such as TCP/IP for messaging and heartbeat signals. Other connections such as a SCSI (not shown) may also be used.

Data processing is aided by the use of physical file systems as shown at 112 and is further performed through the use of a number of user applications, shown at 118 and data management applications (DM) shown at 116 for the session node 110(a) and at 117 for other nodes 110(b) through (n), respectively in FIG. 2. The computing nodes 110(a) through 110(n) in the cluster 100 are capable of running both user applications and data management applications individually, or when required, cooperatively and in parallel. Consequently, the applications running on each node may be either single node, or parallel, multi-node applications.

In a preferred embodiment, as discussed earlier, a Data Management Application Programming Interface (DMAPI) is also provided as shown at 114 in FIG. 2. A physical file system with DMAPI is typically supplied as a software package for installation on the particular cluster, with or without a complete operating system. The software may be downloaded, or supplied by other means such as a CD-ROM, or even electronically over a network or even over the Internet.

In the embodiment illustrated in FIG. 2, node 110(a) is selected by the DM application to be the coordinating node, hereinafter referenced as the “session node.”The session node 110(a) receives and coordinates data movement requests required to perform tasks and/or execute commands by other nodes 110(b) though 110(n) in the cluster. Upon the receipt of such a request, the session node then posts or dispatches worker threads to other available nodes in the cluster that are able to perform the data movement task. This concept is explored in greater detail in conjunction with the flowchart diagram of FIG. 4. However, to better understand that flowchart, certain foundations need to be first established.

When a DM application is running on one or more nodes, the data management application uses the DMAPI to track and control file operations and to manage file data of file systems in the cluster. DMAPI uses mechanisms and infrastructure provided by the physical or parallel file systems including communication, memory management, locking and synchronization for this purpose.

In order to organize data processing requests, DMAPI uses the concept of “events.” An event is similar to a task processing request in other environments. In an environment having a DMAPI, the operating system informs the particular data management application running in the user space whenever a particular specified event occurs such as a user application request to read a certain area of a file. The events are either specified as “synchronous” or “asynchronous.” In a synchronous event, the data management application notifies the operating system of the event and waits for a response before proceeding with further processing, whereas in an asynchronous event the data management application notifies the operating system and proceeds to process the event without waiting for a response.

Data processing is conducted through communications between the data management applications and various nodes and resources. Since more than one operating system and data management application are running at any one time in the environment, the communication between any particular operating system and the data management application is session-based. The data management application creates a session by an appropriate DMAPI function call such as a dm_create_session command. The application then registers event dispositions for the session, indicating which event types in a specified file system should be delivered to the session. Multiple sessions can also exist simultaneously and events in a given file system may be delivered to any of these sessions.

A session may obtain access rights to a file or collection of files. Access rights requested may either be for shared access with other processes, such as creating read only rights, or exclusive rights, as in read-write rights. The access request is made explicitly by the DM application to the file system. Internally, the file system uses a token to enforce these rights.

In the embodiment provided in FIG. 2, the file system at the session node 110(a) provides the access rights (in form of this token) to the file system instance at the worker node, that is the available node to which the worker threads have been dispatched by the session node. The file system honors those rights when processing data operations initiated by the worker node. The state of a synchronous event is further controlled through the use of this token as well. The token can provide reference to the state of a synchronous event message, and may be passed from thread to thread of a data management application. The state also includes lists of files affected by the event, as well as data management access rights in force for those files. A session may obtain access rights to a file or collection of files. This is done through an explicit request by the DM application to the file system. Internally, the file system uses a token to enforce these rights. The rights get passed from the coordinator to the worker. The file system then honors those rights when processing data operations initiated by the worker.

A SAN layer model is illustrated in FIG. 3. The SAN model of FIG. 3 can be categorized in three layers. Layer 1, as shown at 310, includes the hardware and software layers and may be considered the lowest level. This layer is necessary in establishing a working SAN.

Layer 2 as provided by 320 provides management of various components of the SAN. Tools for monitoring and management of the LAN are provided at this layer.

Layer 3 as shown at 330 provides the tools necessary for establishing a distributed, shared file system such as the one discussed in FIG. 1. Layers 1 and 2 provide a storage infrastructure which allows all SAN connected nodes to potentially have access to all SAN connected storage. Layer 3 provides the ability for SAN connected nodes to share data residing in the cluster. This data sharing, however, does not necessarily mean that DM applications residing in the cluster can have parallel access to the data, especially when such data movement involves data to be transferred from a disk to or from a tape drive or other kind of tertiary storage, a problem addressed by the invention. Shared high speed access is crucial for clustered computing and distributed file systems. In addition, access controls, management of files and data integrity have to be maintained at the same time that data requests are being handled quickly and seamlessly.

In FIG. 3, other SAN services are shown alongside the three layers at 340. Such value added SAN services may include such services as interoperability testing, integration and support services to name a few. In addition to such SAN services a hierarchical storage management system such as the data management application described above operates to perform storage management, such as managing private tape libraries, making archive decisions and journaling the storage so that data can be retrieved at a later date.

A method of managing data movement in a cluster according to an embodiment of the invention is illustrated in FIG. 4, which is described as follows, with additional reference to FIG. 2. As shown at 410, a request to access particular data is made by a user application 118 on a node, such as node 110(b), for example. In an embodiment of the invention, the user application 118 requests a file using the name of the file, e.g., “filename.doc.” The name of the file is then converted to a file handle such as “123456”, as by table lookup. The file handle is then used by the file system 112 and the DM application to identify the file.

It is often the case that data resides on tape drives or other tertiary storage apart from the file system because of the infrequency that the particular data is used and the cost of maintaining the storage. When the requested data is not available within the file system, it is necessary to move the data to and from such tertiary storage. On the other hand, sometimes infrequently used data residing on the file system should be moved back to tape or other tertiary storage to allow more frequently used data to be stored therein. The embodiments of the invention are particularly directed to streamlining data movement in such instances. While the embodiments are described below in terms of moving data from such tertiary storage to the file system, the movement of data from the file system to tertiary storage is managed in much the same way. In such case, rather than requesting access to certain data, specified data (generally files) are requested to be moved from the file system to tertiary storage.

After receiving the request for access by user application 118, the file system 112 of the requesting node 110(b) determines whether the data is available within the file system anywhere within the cluster. When the file system 112 of the requesting node 110(b) concludes that the data is not readily available, an event is then generated, as shown at 420. The event is sent out to the coordinating node, also referred to herein as “session node” 110(a), and is reported through the DMAPI interface 114 to the DM application 116 of the session node, as shown at 430. The DM application 116 running of the session node then directs the work to a particular node, for example 110(c), in the cluster, based on availability of a node, as shown at 440. This is done by posting a worker thread to the available node 110(c). A worker 117 on node 110(c) then becomes in charge of processing the requested work.

In an embodiment of the invention, a node is “available” when the node, e.g. 110(c), already has a worker application 117 running on the node. Such worker application is desirably configured as a subset of the DM application 116 which runs on node 110(a) for performing data movement within the cluster 100. In such case, the worker is previously started and waiting for work, and begins handling the work after being posted by the session node 110(a). In another embodiment, a node is “available” when the node, e.g. node 110(n), is in a condition that a worker application can be started thereon by a worker thread created and sent thereto by the session node.

Using the above approach, several events can be generated and sent to the session node 110(a) by one or more requesting nodes. In response to such events, the session node 110(a) posts worker threads to potentially many worker applications 117 on the various nodes of the cluster for the purpose of moving the data from the tertiary storage to the file system (or in the other direction, as described above).

In performing the requested work, for example, for a file access request, the worker application 117 on a node 110(c) through its instances of the DM interface 114 and file system 112 moves the data from the tertiary storage to the file system. The worker then reports the completion of the data movement back to the DM application 116 of the session node 110(a), as shown at 450. The DMAPI application 116 of the session node 110(a) then reports that the event is completed, i.e., that the data is now on the file system, back to the instance of the DMAPI interface 114 of the requesting node 110(b), which then reports it to the user application 118 on the requesting node 110(b).

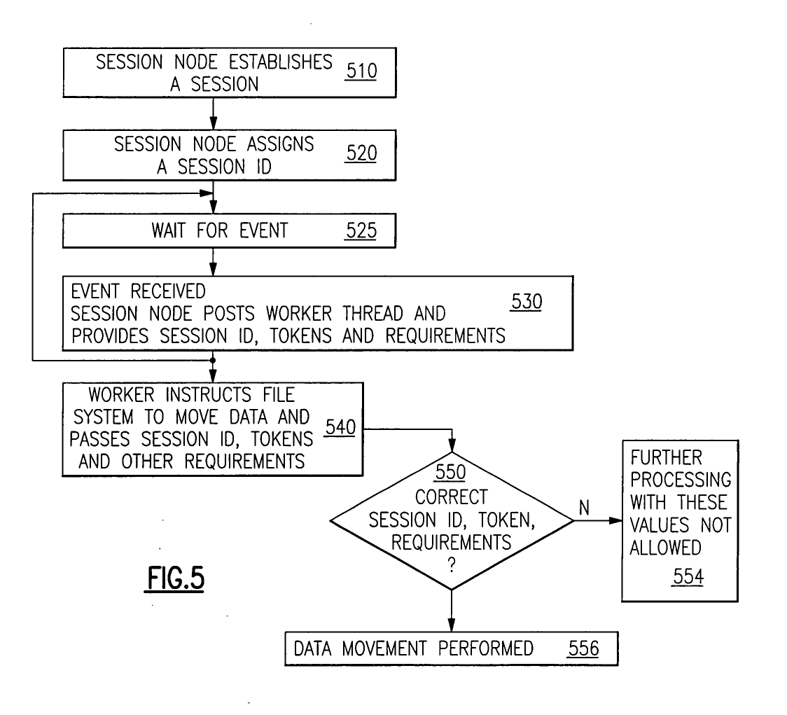

FIG. 5 is a flowchart illustrating further details for performing data movement according to an embodiment of the invention. The DMAPI application 116 of the session node 110(c) establishes a session, as shown at 510. In order to identify incoming or outgoing communications that belong to that session, a session identifier or session “key” is registered on the session node, as shown at 520. The session node then waits for the occurrence of an event, as shown at 525. Upon receiving an event, the session node posts a worker thread to a particular worker 117 on a node, e.g. node 110(c). Alternatively, the session node starts a worker 117 on the particular node, as described above. The session node also provides the session id, the file handle for the file to be accessed, file rights, any token or other requirements, as shown at 530.

The worker application 117 on the worker node 110(c), through its DMAPI interface 114, then instructs the file system instance 112 on that node to perform the data movement, passing the session id, the file handle, file rights, along with any token and any requirements, as shown in 540. The file system instance 112 on the worker node then validates the session id or key, the file rights and the event with the file system instance on the session node, as shown at 550. If the correct information is provided, the request is honored by the file system, and the data is moved from tertiary storage to the file system, under control of the file system instance 112 running on the worker node 110(c), as shown at 556. However, if correct information is not provided, the request is not honored, as shown at 554.

It should be noted that the session id is passed to a worker when a worker thread is posted. The worker may then make data movement calls by passing the session id or session key which it obtains from the data management application to the node. In a preferred embodiment, the workers may only execute those calls which move data into or out of a file system or that punch a hole in a file. For example, the following three commands may be particularly are used: dm_invis_read, dm_invis_write and dm_punch_hole calls). In a particular embodiment of the invention, there may be multiple worker threads per file which allows parallel movement of data at a subfile level as well as at a file level.

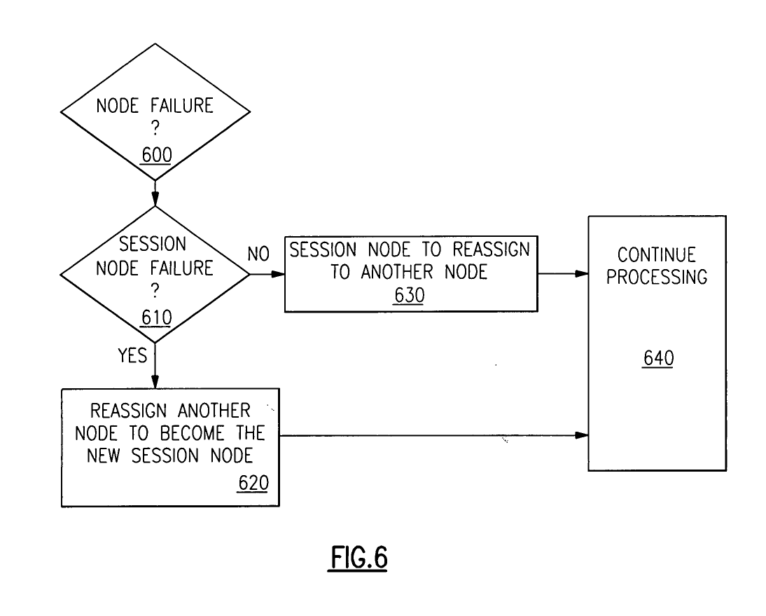

System and node failures can be compensated, as shown in FIG. 6 at 600. In case a node or a worker thread fails, the operation can be retried on another node, without the original application needing to know of the failure. When a node fails, it is determined by the DM application 116 as whether the failing node is a session node or a worker node, as shown at 610. If the node experiencing a failure is a node other than the session node, the session node will be in charge of posting worker thread to another node, as shown at 620. In case the session node encounters a failure itself, the DM application can reassign coordination tasks to any other node in the cluster, as shown at 620. In either case, the processing will resume after such reassignment, as shown at 640.

In any environment that uses an HSM, the process described by the flow chart of FIG. 4 can be used to allow the data movement portion of HSM processing to be parallelized without parallelizing the data control portion of the HSM product. Producing a fully parallel HSM application would require extensive and complex locking on the data structures used to control the migration and recall of data. The technique presented here allows the central event handling to create data movement threads on other computing machines which operate asynchronously to the event handling and merely report back success or failure. There is no multiple node serialization required.

Consequently, the process discussed in FIG. 4 provides a multi-node approach that provides for greater movement capabilities than the prior art methods. In the implementation described by the previous filings, the DM application was registered on a single node of the cluster and all events and data movement occurred on that node. This node although also identified as a session node is very different than the session node of the present application. In the previous filings the session node had complete processing control instead of only a coordinating role. For example, in a commonly owned, co-pending filing of the inventors, the user action that provoked an event could occur on any node. Thereafter, the user process would then be suspended, a message forwarded by the local file system to the session node, and an event presented to the data management application on the session node. From then on, all actions required to satisfy the event would be performed on the session node using the keys associated with that session. The embodiments of the present invention described herein provide a way of maintaining data management event handling on one coordinating node, while assigning the data movement tasks thereunder to available nodes within the cluster. This eliminates a single server bottleneck for the movement of data. This is critical when dealing with very large files and large numbers of them. An alternative would be to present DMAPI events at every node in the file system. This would potentially allow parallel data movement in the same way as the present application. However, such would require that the data management application implement a fully distributed event handling and rights algorithm with recovery. This is not a simple task and has been a barrier in prior art systems.

Furthermore, the embodiments of the invention take advantage of existing application designs. The concept of existing worker threads in any DM application such application is exploited to boost performance. The present invention posts worker threads, i.e. either signals a waiting worker, or creates and dispatches (such as on the session node itself) and makes it possible for the heavy lifting portion of the data management application to be performed in parallel without requiring fully distributed locking and control.

While the invention has been described in detail herein in accord with certain preferred embodiments thereof, many modifications and changes therein may be effected by those skilled in the art. Accordingly, it is intended by the appended claims to cover all such modifications and changes as fall within the true spirit and scope of the invention.

1. A method of managing data movement, comprising:
establishing a processing environment in a cluster of nodes having common access to data residing in one or more data storage units;
initiating a data management application (DM) in said environment;
assigning a node of said cluster as a coordinating node for managing data movement;
receiving an event by the coordinating node requesting movement of data;
posting a worker thread to one or more of the nodes to perform data movement in response to the event.

2. The method of claim 1, wherein said worker threads are posted to one or more nodes other than said coordinating node to perform data movement tasks.

3. The method of claim 1, wherein said coordinating node is a session node.

4. The method of claim 1, further comprising providing data management access rights to the one or more nodes to which said worker threads are posted, and permitting only the one or more nodes having said data management access rights to execute said worker threads.

5. The method of claim 1, further comprising establishing a process session in said cluster and assigning a session identifier for that session.

6. The method of claim 5, further comprising providing said session identifier to said one or more nodes to which said worker threads are posted, and permitting only the one or more nodes having said session identifier to execute said worker thread.

7. The method of claim 5, wherein said DM application establishes said session and assigns said session identifier.

8. The method of claim 5, wherein a plurality of sessions are established in said cluster concurrently and each session is assigned a unique session identifier.

9. The method of claim 1, wherein said DM application utilizes one or more parallel file systems for management of data.

10. The method of claim 9, wherein each parallel file system further comprises one or more physical file systems.

11. The method of claim 10, wherein said worker threads include calls for performing at least one of punching holes in files, moving data into files and moving data out of files.

12. The method of claim 9, wherein said DM application is initiated using a data management application programming interface (DMAPI).

13. The method of claim 1, wherein said DM application is initiated using a data management application programming interface (DMAPI).

14. The method of claim 1, wherein said processing environment includes a storage area network (SAN) including said one or more data storage units.

15. The method of claim 12, wherein said processing environment includes a storage area network (SAN) including said one or more data storage units.

16. The method of claim 14, wherein said worker threads perform data movement within a hierarchical storage management (HSM) system.

17. The method of claim 1, further comprising reassigning a worker thread to another node upon failure of the node to which the worker thread is dispatched.

18. The method of claim 1, further comprising assigning another coordinating node upon failure of the coordinating node.

19. A machine readable medium having a set of instructions recorded thereon for performing a method of managing data movement, said method including:
establishing a processing environment in a cluster of nodes having common access to data residing in one or more data storage units;
initiating a data management application (DM) in said environment;
assigning a node of said cluster as a coordinating node for managing data movement;
receiving an event by the coordinating node requesting movement of data;
posting a worker thread to one or more of the nodes to perform data movement in response to the event.

20. A system for managing data movement comprising;
a computing environment having a cluster of nodes having common access to data residing in one or more data storage units;
a data management application (DM) operable to manage data movement by assigning any node in said cluster as a coordinating node to manage data movement events and dispatching worker threads to one or more nodes to perform data movement tasks in response to the data movement events.
